(19) United States
(12) Patent Application Publication
(10) Pub. No.: US 2011/0157908 A1
(43) Pub. Date: Jun. 30, 2011

(54) ILLUMINATING DEVICE FOR VEHICLE

(75) Inventors: Shiro IWAI, Tochigi-ken (JP); Koji IMAIZUMI, Utsunomiya-shi (JP); Aika SAITO, Utsunomiya-shi (JP); Ryoichi ENOKI, Utsunomiya-shi (JP)

(73) Assignee: HONDA ACCESS CORP., Niiza-shi (JP)

(21) Appl. No.: 12/878,591

(22) Filed: Sep. 9, 2010

(30) Foreign Application Priority Data
Dec. 24, 2009 (JP) 2009-292833

(51) Int. Cl. F21V 11/00

(52) U.S. Cl. 362/509

(57) ABSTRACT

There is provided an illuminating device for vehicle which can be protected from penetration of, for example water. An illuminating device 1 for vehicle comprises a light source 7 and a lighting main body 2 that transmits light irradiated from the light source 7 and then emits the light outward. The lighting main body 2 includes a light guide body 5 and a casing 6 formed integrally with the light guide body 5. The casing 6 has a light source installation portion 11 for installing the light source 7 and a cover 4 which covers only the light source installation portion 11. A gap is sealed between the light source installation portion 11 and the cover 4.

### BACKGROUND OF THE INVENTION

1. Field of the Invention

The present invention relates to an illuminating device for vehicle, in particular, to an illuminating device for vehicle suitably used for an indirect lighting whose light is emitted from a light source through a light guide body.

2. Description of the Related Art

Japanese Unexamined Patent Application Publication No. 2002-279817, for example, discloses, as such illuminating device for vehicle, a scuff plate illuminating device including a light guide body, a light source unit, a character panel and a transparent sheet. The transparent sheet covers over an illuminating view side of the character panel after the light source unit and the character panel are assembled and attached to the light guide body. The outer peripheral edge of the transparent sheet is bonded to that of the light guide body, so that the scuff plate illuminating device can protect the light guide body from penetration of, for example, dust or water.

According to the above conventional art, it is difficult to wholly bond the outer peripheral edge of the transparent sheet to the outer peripheral edge of the light guide body. Thus, the conventional art does not make it possible to protect the light guide body from penetration of, for example, water, leading to problems such as lighting failure of the light source unit.

### SUMMARY OF THE INVENTION

In view of the above problem, it is an object of the present invention to provide an illuminating device for vehicle which can be protected from penetration of water or the like.

In order to achieve the above object, a first aspect of the present invention is a vehicle illuminating device comprising: a light source; a lighting main body transmitting light irradiated from said light source and radiating said light outward, wherein said lighting main body includes a light guide body and a case integrally formed together with said light guide body, said case has a light source installation portion for installing said light source, and said light source installation portion is sealed with a cover which covers only said light source installation portion.

According to a second aspect of the present invention, said light guide body is provided with a step portion on one end side which receives said light from said light source, and a one surface of said light guide body is formed to be flat against a surface of said cover.

According to the first aspect, places to be sealed can be decreased substantially compared to the conventional art which seals whole places. Thus the vehicle illuminating device of the present invention can more certainly be protected from penetration of, for example, water.

According to the second aspect, the vehicle illuminating device of the present invention can enhance its design property.

### BRIEF DESCRIPTION OF THE DRAWINGS

The invention will be more readily understood by reference to the following description, taken with the accompanying drawings, in which:

FIG. 1 is a perspective view showing the entire structure of an illuminating device for vehicle according to the present invention, in which FIG. 1 (A) shows a light guide body and a cover, (B) shows a casing, and (C) shows the illuminating device for vehicle; and,

FIG. 2 is a partially enlarged sectional view of the illuminating device for vehicle according to the present invention.

### DETAILED DESCRIPTION OF THE PREFERRED EMBODIMENTS

The following is a detailed description of preferred embodiments of the present invention with reference to the appended drawings.

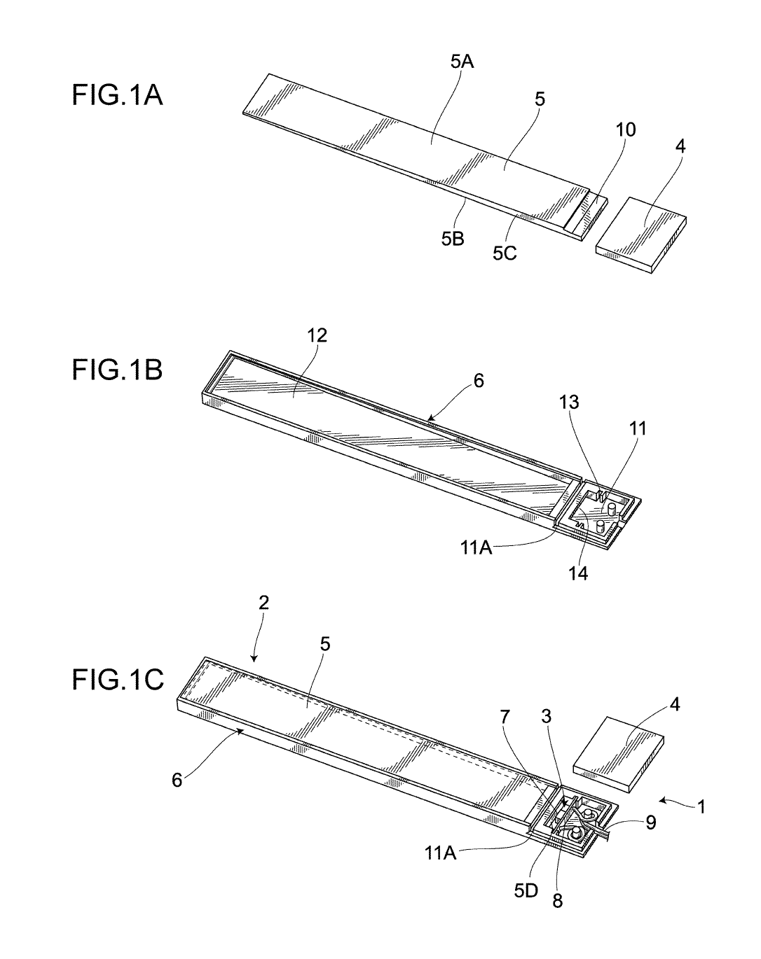

A illuminating device 1 for vehicle shown in FIG. 1 includes a lighting main body 2, a light source unit 3, and a cover 4. The lighting main body 2 comprises a light guide body 5 and a casing 6 formed integrally with the light guide body 5.

The light source unit 3 has a light source 7 and a substrate 8 with the light source 7 installed thereon. To the substrate 8 is electrically connected a power cable 9, which is then electrically connected to a battery (not shown). The light source 7 is not limited to any specific element, but in this embodiment, an LED (Light emitting Diode), for example, may be utilized as the light source 7.

The illuminating device 1 for vehicle is constituted so as to illuminate the light source 7 by electric power supplied through the power cable 9 to thereby use the light irradiated from the light source 7 as an indirect lighting via the light guide body 5. The illuminating device 1 for vehicle has a rectangular plate shape.

The light guide body 5 is made up of a rectangular plate body, and a step portion 10 is formed on a first surface 5A of the light guide body 5 at its one end in the longitudinal direction thereof. The light guide body 5 is formed gradually thinner from the one end to the other end. The first surface 5A of the light guide body 5 is formed with letters and/or patterns (not shown) by a printing process. The casing 6 is rectangular plate-shaped, and a light source installation portion 11 and a light guide body installation portion 12 are formed on the casing 6.

The light source installation portion 11 comprises a recess formed on one end of the casing 6, and is provided with a holding groove 13 for holding the substrate 8 of the light source unit 3. A cover receiving portion 11A is formed on the light source installation portion 11 in a manner surrounding an outer circumferential edge thereof.

The light guide body installation portion 12 is provided next to the light source installation portion 11 and is formed so as to be able to cover a second surface 5B and an outer circumferential edge 5C of the light guide body 5. Further, the light guide body installation portion 12 is communicated with the light source installation portion 11 through a light guide body insertion portion 14.

The cover 4 is formed so as to be able to cover only the light source installation portion 11 and is boned to the cover receiving portion 11A formed on the outer circumferential edge of the light source installation portion 11.

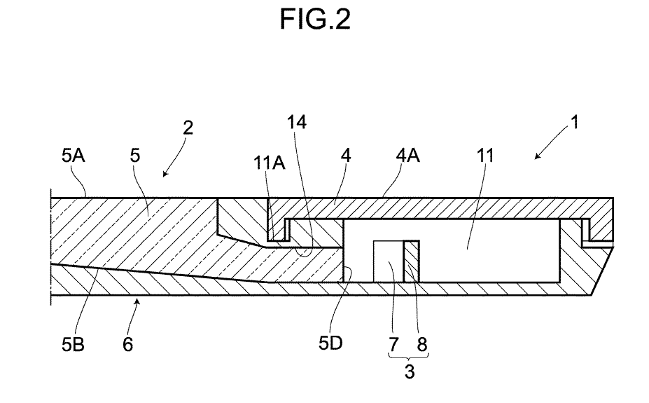

As shown in FIG. 2, the light guide body 5 is formed integrally with the casing 6 with a light introducing portion 5D formed at one end of the light guide body 5 being directed toward the light source installation portion 11 through the light guide body insertion portion 14.

The light source unit 3 is fixed on the light source installation portion 11 so as to irradiate light from the light source 7 toward the light introducing portion 5D of the light guide body 5.

According to the present embodiment, the lighting main body 2 is produced by integrally forming the light guide body 5 and the casing 6. In this case, the light guide body 5 is formed in advance by pouring a material of the light guide body 5 into a first mold which is not shown. And then, the light guide body 5 and the casing 6 are integrally formed by putting the light guide body 5 in a second mold and then pouring a material of the casing 6 into a gap between the light guide body 5 and the second mold. As a result, the gap between the light guide body 5 and the casing 6 is filled, thus providing a single-piece structure composed of the light guide body 5 and the casing 6.

With the lighting main body 2 formed in this manner, the substrate 8 is inserted into the holding groove 13, and the light source unit 3 is fixed to the light source installation portion 11. And then, the cover 4 is placed on the light source installation portion 11. After that, a gap between the cover 4 and the cover receiving portion 11A is filled with an adhesive and sealed, so that the cover 4 is boded to the casing 6. In this manner, the light source installation portion 11 is sealed with the cover 4. Practically, the light source installation portion 11 has an opening for pulling out the power cable 9 from thereinside and is completely sealed by filling a resin adhesive into the opening.

According to the above-structured illuminating device 1 for vehicle, when an electric power is supplied to the light source unit 3 through the power cable 9 by turning on a switch which is not shown, the light source 7 is illuminated by the electric power. The light irradiated from the light source 7 is transmitted into the interior of the light guide body 5 from the light introducing portion 5D and is emitted outward from the first surface 5A of the light guide body 5.

Since the lighting main body 2 is produced by forming the light guide body 5 integrally with the casing 6, the illuminating device 1 for vehicle can be protected from penetration of water or the like through sealed parts between the light guide body 5 and the casing 6, and thus it has only to seal the gap between the cover 4 and the cover receiving portion 11A. In this way, compared to the conventional arts where sealing is applied wholly, the illuminating device 1 for vehicle of the present invention can substantially decrease the parts to be sealed, thus enabling the penetration of water or the like to be prevented more reliably.

The casing 6 is formed integrally with the light guide body 5 such that the light guide body installation portion 12 may cover over the second surface 5B and outer circumferential edge 5C of the light guide body 5. In this way, the illuminating device 1 for vehicle can decrease the number of assembling parts as well as transportation and production costs compared to the conventional arts in which the light guide body 5 is separately provided.

Furthermore, since the lighting main body 2 is produced by integrally forming the light guide body 5 and the casing 6, the illuminating device 1 for vehicle can enhance its mechanical strength, so that a thickness of the casing 6 can be made thinner than those of the conventional arts. Therefore, the illuminating device 1 for vehicle enables the reduction of thickness of the casing 6 covering the outer circumferential edge 5C of the light guide body 5, so that it is possible to make the dimension of the light guide body 5 larger, eventually enabling its light-irradiating area to irradiate light outward to be increased.

Since the step portion 10 is provided on the one end of the light guide body 5, the first surface 5A of the light guide body 5 can be formed substantially flush with a surface 4A of the cover 4, so that the illuminating device 1 for vehicle can enhance its design property.

Since the casing 6 is provided with the cover receiving portion 11A, and the cover 4 is bonded to the cover receiving portion 11A, it is possible to prevent the cover 4 from contacting the light guide 5. Thus, the illuminating device 1 for vehicle can protect the light guide body 5 from being damaged during, for example, its production.

Moreover, according to the lighting main body 2, the light guide body 5 is formed integrally with the casing 6 with the light introducing portion 5D of the light guide body 5 being inserted through the light guide body insertion portion 14 provided on the casing 6. Accordingly, its assembling work can be simplified, while enabling the light introducing portion 5D to be properly located in a given place. Thus, the illuminating device 1 for vehicle can achieve reduction of production costs, while making it possible to effectively transmit the light from the light source 7 to the light guide body 5.

Additionally, since the light guide body 5 is formed gradually thinner from the one end to the other end, it is possible to irradiate the light with uniform brightness over the whole longitudinal length thereof.

### (Modification)

The present invention is not limited to the foregoing embodiment and various modifications are possible within the scope of the gist of the present invention. For example, although letters and patterns are formed on the first surface 5A of the light guide body 5 by a printing process in the foregoing embodiment, the present invention is not limited thereto, but letters and patterns which are cut out from a film may be fixedly provided on the first surface 5A of the light guide body 5.

What is claimed is:

1. An illuminating device for vehicle comprising:
a light source;
a lighting main body for transmitting light irradiated from the light source and then emitting the light outward, wherein
said lighting main body includes a light guide body and a casing formed integrally with the light guide body;
said casing includes a light source installation portion for installing said light source, and
said light source installation portion is sealed with a cover which covers said light source installation portion only.

2. The illuminating device for vehicle according to claim 1, wherein said light guide body is provided with a step portion on one end where light from said light source is received, while at least one side of said cover is placed on said step portion so that one surface of the light guide body is formed flush with a surface of the cover.

3. The illuminating device for vehicle according to claim 1, wherein said light guide body is formed gradually thinner from one end to other end.

4. The illuminating device for vehicle according to claim 1, wherein said light guide body introduces the light irradiated from said light source to the interior of said light guide body and emits the light outward from said one surface of the light guide body as indirect lighting.
